(19) United States
(12) Patent Application Publication
(10) Pub. No.: US 2023/0042305 A1
(43) Pub. Date: Feb. 9, 2023

(54) RECOMMENDATION METHOD AND SYSTEM

(71) Applicant: ServiceNow Canada Inc., Montreal (CA)

(72) Inventors: Raymond LI, Montreal (CA); Christopher PAL, Montreal (CA)

(73) Assignee: ServiceNow Canada Inc., Montreal, QC (CA)

(21) Appl. No.: 17/758,424

(22) PCT Filed: Jan. 7, 2021
(86) PCT No.: PCT/IB2021/050103

§ 371 Date: Jul. 6, 2022

Related U.S. Application Data
(60) Provisional application No. 62/957,855, filed on Jan. 7, 2020.

(51) Int. Cl. G06F 40/35; G06F 40/40; G06F 40/284

(52) U.S. Cl. CPC G06F 40/35; G06F 40/40; G06F 40/284

(57) ABSTRACT

There is provided a method and system for training and using a transformer language model (TLM) part of a recommendation engine. Natural language discussions about a category of items are received, the discussions comprising tags each indicative of a respective item belonging to the category of item. Information is received for each respective item. Based on the natural language discussions, the tags and the information about the respective item, the TLM is trained to: upon receipt of a user input, determine whether a given item should be recommended based on the user input, if the given item should be recommended, retrieving given information about the given item and generating a response to the user input, the response to the user input comprising the given item to be recommended and the given information, and output the response to the user input. The response is generated in natural language format.

### CROSS-REFERENCE TO RELATED APPLICATION

The present application claims priority on U.S. Provisional Patent Application No. 62/957,855 filed on Jan. 7, 2020.

### TECHNICAL FIELD

The present technology relates to the field of recommendation methods and systems, and more particularly to recommendation methods and systems using transformer neural networks.

### BACKGROUND

Transformers are getting more and more interest from the natural language processing (NLP) community because of their ability to capture long-term context (compared to recurrent neural networks). Transformer language models (TLM), such as GPT-2 model by OpenAl are a particular type of transformers that only use the decoder. Being trained on massive amounts of data, these models produce fluent answers that remain coherent with a long context. CTRL is another TLM that is given control codes during training that govern the style and content of the text. This allows the user to obtain control on the behavior of the model at inference, by specifying certain control codes. However, neural language generating models have the tendency to hallucinate and imagine facts that are actually wrong. TLMs are no exception to this.

Therefore, there is a need for an improved method and system for recommendations using TLMs.

### SUMMARY

In accordance with a broad aspect of the present technology, there is provided a method for training a transformer language model (TLM) to provide responses includes item recommendation, the method is executed by a processor, and the processor executes the

TLM. The method comprises: receiving natural language discussions about a category of items, the discussions includes tags each indicative of a respective item belonging to the category of items, for each respective item, receiving information about the respective item, and based on the natural language discussions, the tags and the information about the respective item, training the TLM to: upon receipt of a user input, determine whether a given item should be recommended based on the user input, if the given item should be recommended, retrieving given information about the given item and generating a response to the user input, the response to the user input includes the given item to be recommended and an indication of the given information, and output the response to the user input.

In one or more embodiments of the method, said response is generated in the form of a natural language dialogue sentence.

In one or more embodiments of the method, the processor is connected to a knowledge data source, and said retrieving given information about the given item comprises providing an indication of the respective item to the knowledge data source to receive the information therefrom.

In one or more embodiments of the method, to determine whether a given item should be recommended based on the user input, the TLM is trained to generate a control token includes a recommendation value and a non-recommendation value, and said retrieving given information about the given item if the given item should be recommended is based on the recommendation value is above the non-recommendation value.

In one or more embodiments of the method, said generating the control token comprises matching character sequences from the user input to items in the category of items.

In one or more embodiments of the method, the method further comprises: generating, using a recommendation engine connected to the processor, based on the user input, the given item to be recommended.

In one or more embodiments of the method, the method further comprises if the given item should not be recommended, generating a discussion line about the category of items as the response.

In accordance with a broad aspect of the present technology, there is provided a method for recommending items using a transformer language model (TLM) having been trained therefor, the method is executed by a processor. The method comprises: receiving a user input includes a natural language discussion line, determining, based on the natural language discussion line, a given item related to a category of items, generating, using the TLM, based on the item related to a category of items, a recommendation value, if the recommendation value is above a threshold: receiving a given recommended item from a recommendation engine, receiving information about the given recommended item from a knowledge source, generating, using the TLM, based on the information about the given recommended item and the given recommended item, a natural language response to the user input includes the given recommended item and an indication of the information, and outputting the natural language response.

In one or more embodiments of the method, the method further comprises, prior to said receiving the user input: receiving natural language discussions about the category of items, the discussions includes tags each indicative of a respective item belonging to the category of items, for each respective item, receiving information about the respective item, and based on the natural language discussions, the tags and the information about the respective item, training the TLM to generate natural language responses.

In one or more embodiments of the method, the given recommended item has not been used to train the TLM.

In accordance with a broad aspect of the present technology, there is provided a system for training a transformer language model (TLM) as part of a recommendation engine. The system comprises: a processor, and a non-transitory computer readable storage medium including instructions stored thereon, the processor, upon execution of the instructions, is configured for: receiving natural language discussions about a category of items, the discussions includes tags each indicative of a respective item belonging to the category of items, for each respective item, receiving information about the respective item, and based on the natural language discussions, the tags and the information about the respective item, training the TLM to: upon receipt of a user input, determine whether a given item should be recommended based on the user input, if the given item should be recommended, retrieving given information about the given item and generating a response to the user input, the response to the user input includes the given item to be recommended and an indication of the given information, and output the response to the user input.

In one or more embodiments of the system, said response is generated in the form of a natural language dialogue sentence.

In one or more embodiments of the system, the processor is connected to a knowledge data source, and said retrieving given information about the given item comprises providing an indication of the respective item to the knowledge data source to receive the information therefrom.

In one or more embodiments of the system, to determine whether a given item should be recommended based on the user input, the processor is configured for training the TLM to generate a control token includes a recommendation value and a non-recommendation value, and said retrieving given information about the given item if the given item should be recommended is based on the recommendation value is above the non-recommendation value.

In one or more embodiments of the system, said generating the control token comprises matching character sequences from the user input to items in the category of items.

In one or more embodiments of the system, the processor is further configured for: generating, using the recommendation engine connected to the processor, based on the user input, the given item to be recommended.

In one or more embodiments of the system, the system further comprises if the given item should not be recommended, generating a discussion line about the category of items as the response.

In accordance with a broad aspect of the present technology, there is provided a system for recommending items using a transformer language model (TLM) having been trained therefor. the system comprises: a processor, and a non-transitory computer readable storage medium includes instructions stored thereon, the processor, upon execution of the instructions, is configured for: receiving a user input includes a natural language discussion line, determining, based on the natural language discussion line, a given item related to a category of items, generating, using the TLM, based on the item related to a category of items, a recommendation value, if the recommendation value is above a threshold: receiving a recommended item from a recommendation engine,

receiving information about the recommended item from a knowledge source, generating, using the TLM, based on the information about the recommended item and the recommended item, a natural language response to the user input includes the given item to be recommended and an indication of the given information, and outputting the natural language response.

In one or more embodiments of the system, the processor is further configured for, prior to said receiving the user input: receiving natural language discussions about the category of items, the discussions includes tags each indicative of a respective item belonging to the category of items, for each respective item, receiving information about the respective item, and based on the natural language discussions, the tags and the information about the respective item, training the TLM to generate natural language responses.

In one or more embodiments of the system, the given recommended item has not been used to train the TLM.

In the context of the present specification, a “server” is a computer program that is running on appropriate hardware and is capable of receiving requests (e.g., from electronic devices) over a network (e.g., a communication network), and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “electronic device” is any computing apparatus or computer hardware that is capable of running software appropriate to the relevant task at hand. Thus, some (non-limiting) examples of electronic devices include general purpose personal computers (desktops, laptops, netbooks, etc.), mobile computing devices, smartphones, and tablets, and network equipment such as routers, switches, and gateways. It should be noted that an electronic device in the present context is not precluded from acting as a server to other electronic devices. The use of the expression “an electronic device” does not preclude multiple electronic devices being used in receiving/sending, carrying out or causing to be carried out any task or request, or the consequences of any task or request, or steps of any method described herein. In the context of the present specification, a “client device” refers to any of a range of end-user client electronic devices, associated with a user, such as personal computers, tablets, smartphones, and the like.

In the context of the present specification, the expression “computer readable storage medium” (also referred to as “storage medium” and “storage”) is intended to include non-transitory media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct-wired connection, and wireless media such as acoustic, radio frequency (RF), infrared and other wireless media, as well as combinations of any of the above.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description and the accompanying drawings.

### BRIEF DESCRIPTION OF THE DRAWINGS

Further features and advantages of the present invention will become apparent from the following detailed description, taken in combination with the appended drawings, in which:

FIG. 1 depicts a schematic diagram of an electronic device in accordance with one or more non-limiting embodiments of the present technology;

FIG. 2 depicts a schematic diagram of a system in accordance with one or more non-limiting embodiments of the present technology;

FIG. 3 is a flow chart illustrating a computer-implemented method for training a transformer language model (TLM), in accordance with one or more non-limiting embodiments of the present technology;

FIG. 4 is a flow chart illustrating a computer-implemented method for recommending an item using a TLM in accordance with one or more non-limiting embodiments of the present technology;

FIG. 5 illustrates a process for recommending movies, in accordance with one or more non-limiting embodiments of the present technology;

FIG. 6 illustrates exemplary experimental results obtained for different fine-tuning variants for questions about actors and directors, the exemplary experimental results having been obtained in accordance with one or more non-limiting embodiments of the present technology; and

FIG. 7 illustrates exemplary experimental results obtained for different fine-tuning variants for questions about writers, the exemplary experimental results having been obtained in accordance with one or more non-limiting embodiments of the present technology.

It will be noted that throughout the appended drawings, like features are identified by like reference numerals.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology.

Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some non-limiting embodiments of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

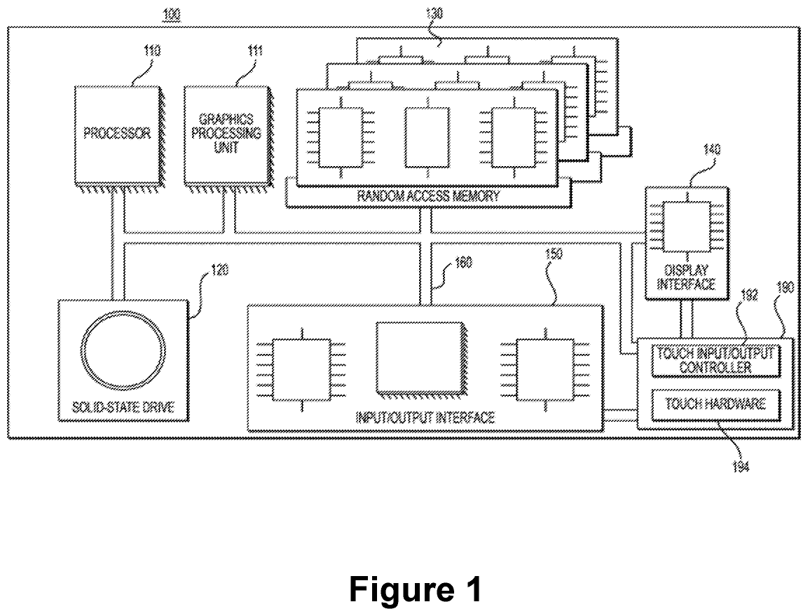

Referring to FIG. 1, there is shown an electronic device 100 suitable for use with some implementations of the present technology, the electronic device 100 comprising various hardware components including one or more single or multi-core processors collectively represented by processor 110, a graphics processing unit (GPU) 111, a solid-state drive 120, a random access memory 130, a display interface 140, and an input/output interface 150.

Communication between the various components of the electronic device 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In some embodiments, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some embodiments, the input/output interface 150 may be connected to a keyboard (not shown), a mouse (not shown) or a trackpad (not shown) allowing the user to interact with the electronic device 100 in addition or in replacement of the touchscreen 190.

According to implementations of the present technology, the solid-state drive 120 stores program instructions suitable for being loaded into the random-access memory 130 and executed by the processor 110 and/or the GPU 111. For example, the program instructions may be part of a library or an application.

The electronic device 100 may be implemented as a server, a desktop computer, a laptop computer, a tablet, a smartphone, a personal digital assistant or any device that may be configured to implement the present technology, as it may be understood by a person skilled in the art.

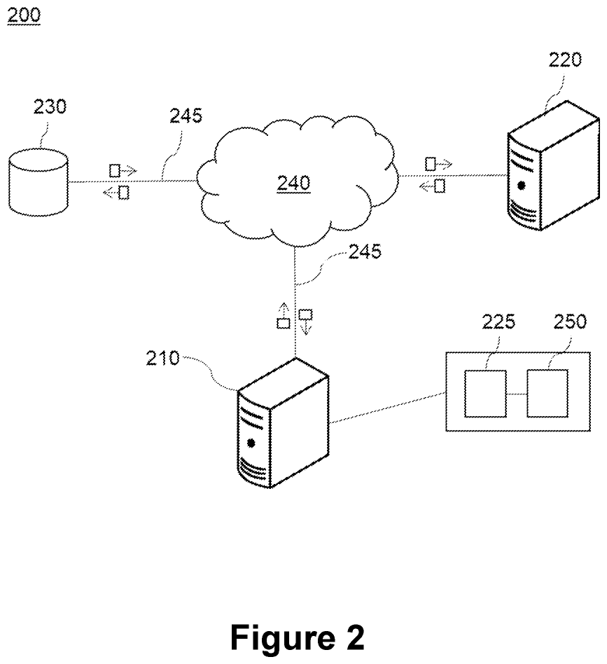

Referring to FIG. 2, there is shown a schematic diagram of a communication system 200, which will now be referred to as system 200, the system 200 being suitable for implementing non-limiting embodiments of the present technology. It is to be expressly understood that the system 200 as shown is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 200 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 200 may provide in certain instances simple implementations of the present technology, and that where such is the case they have been presented in this manner as an aid to understanding. As persons skilled in the art would understand, various implementations of the present technology may be of a greater complexity.

The system 200 comprises inter alia a first server 210, a second server 220 and a database 230 communicatively coupled over a communications network 240 via respective communication links 245 (only one numbered in FIG. 2).

Generally speaking, the first server 210 is configured to inter alia: (i) execute one or more machine learning (ML) models in the form of the transformer language model (TLM) 250 to be used for recommendation of items; (ii) provide an application programming interface (API) 255 to enable electronic device to access the transformer language model 250; (iii) train the TLM 250 as described above; and (iv) determine whether a recommendation should be generated upon receipt of a query and generate recommendations of items via the transformer natural language model 250.

In one or more embodiments, the first server 210 is further configured to inter alfa: (v) determine tokens; and (vi) determine whether a recommendation should be generated based on the values of the determined tokens, as will be described below.

The TLM 250 is configured to generate a response following the receipt of a query. The TLM 250 then determines whether a recommendation for an item should be generated and if so, generates a recommendation for a given item and adds information about the item within the recommendation, as will be described in greater detail below.

In one embodiment, the first server 210 executes a training procedure of the TLM 250. In another embodiment, the training procedure of the TLM 250 may be executed by another electronic device (not shown), and the TLM 250 may be transmitted to the first server 210 over the communications network 240.

In one embodiment, the first server 210 is configured to provide an API 225, which enables accessing the transformer natural language model 250. The API 225 is an interface or communication protocol between the first server 210 and electronic devices connected thereto, such as a user electronic device (not shown). The API 225 may be for example web-based, a database system, or implemented in computer hardware and/or a software library.

The API 225 may be used by electronic devices connected to the first server 210 to access and provide input data to the transformer natural language model 250 for processing thereof and receive the recommendations output by the transformer natural language model 250.

The first server 210 can be implemented as a conventional computer server and may comprise at least some of the features of the electronic device 100 shown in FIG. 1. Needless to say, the first server 210 can be implemented in any other suitable hardware and/or software and/or firmware or a combination thereof. In the shown non-limiting embodiment of present technology, the first server 210 is a single server. In alternative non-limiting embodiments of the present technology, the functionality of the first server 210 may be distributed and may be implemented via multiple servers (not shown).

The implementation of the first server 210 is well known to the person skilled in the art of the present technology. However, briefly speaking, the first server 210 comprises a communication interface (not shown) structured and configured to communicate with various entities (such as the knowledge source 230, for example and other devices potentially coupled to the network) via the network 240. The first server 210 further comprises at least one computer processor (e.g., the processor 110 and/or GPU 111 of the electronic device 100) operationally connected with the communication interface and structured and configured to execute various processes to be described herein.

The system 200 comprises at least one data source 230 communicatively coupled to the first server 210 via the communications network 240 but, in alternative implementations, the data source 230 may be directly and communicatively coupled to the first server 210 without departing from the teachings of the present technology. Although the data source 230 is illustrated schematically herein as a single entity, it is contemplated that the data source 230 may be configured in a distributed manner, for example, the data source 230 could have different components, each component being configured for a particular kind of retrieval therefrom or storage therein.

The data source 230 comprises discussions about items to be used in the training of the TLM 250, and a knowledge source containing information about the items. The discussions to be used for the training of the TLM 250 may be for example stored in a database. As a non-limiting example, the discussions to be used for training may include chat logs, the Wizard of Wikipedia™ dataset, and the like. The discussions may be tagged and formatted for training the TLM 250 to provide recommendations.

The knowledge source may comprise information stored in structured or unstructured format. As a non-limiting example, the knowledges source may comprise a database containing the information about items, a collection of natural language documents such as a local collection of reference text, internal organization documents and web pages, compiled news reports, Wikipedia™ pages, and/or a plurality of web pages, etc.

It will be appreciated that the discussion about the items and the knowledge source may be stored in different data sources accessible via the communications network 240.

The data source 230 may comprise a structured collection of data, irrespective of its particular structure or the computer hardware on which data is stored, implemented or otherwise rendered available for use. The data source 230 may reside on the same hardware as a process that stores or makes use of the information stored in the data source 230 or it may reside on separate hardware, such as on the first server 210 and/or the second server 220. Generally speaking, the data source 230 may receive data from the first server 210 for storage thereof and may provide stored data to the first server 210 for use thereof.

Still referring to FIG. 2, the system 200 also comprises the second server 220.

Generally speaking, the second server 220 executes a recommendation engine configured to recommend items. The recommendation engine may use one or more machine learning models (not shown) for recommending items to user(s), such as sentiment analysis models. It will be appreciated that the one or machine learning models may use different types of features and may be trained on different types of datasets which comprise user interaction data for example. As a non-limiting example, the recommendation engine may be implemented as part of a chatbot which uses the TLM 250 via the API 225.

In one or more embodiments, the second server 220 is configured to inter alia: (i) receive, from the first server 210, a query comprising relevant information about an item or a category of items; (ii) generate, based on the query, one or more recommended items; and (iii) transmit the recommended items to the first server 210.

Similarly to the first server 210, the second server 220 can be implemented as a conventional computer server and may comprise some or all of the features of the electronic device 100 shown in FIG. 1. Needless to say, the second server 220 can be implemented in any other suitable hardware and/or software and/or firmware or a combination thereof. In the shown non-limiting embodiment of present technology, the second server 220 is a single server. In alternative non-limiting embodiments of the present technology, the functionality of the second server 220 may be distributed and may be implemented via multiple servers (not shown).

The implementation of the second server 220 is well known to the person skilled in the art of the present technology. However, briefly speaking, the second server 220 comprises a communication interface (not shown) structured and configured to communicate with various entities (such as the first server 210 and the data source 230, for example and other devices potentially coupled to the network) via the network. The second server 220 further comprises at least one computer processor (e.g., the processor 110 and/or GPU 111 of the electronic device 100) operationally connected with the communication interface and structured and configured to execute various processes to be described herein.

In alternative embodiments of the present technology, the first server 210 and the second server 220 may be implemented as a single server which may provide a recommendation engine and the TLM 250. In other non-limiting embodiments, functionality of the first server 210 and/or the second server 220 may distributed among a plurality of electronics devices.

In some embodiments of the present technology, the communication network 240 is the Internet. In alternative non-limiting embodiments, the communication network 240 can be implemented as any suitable local area network (LAN), wide area network (WAN), a private communication network or the like. It should be expressly understood that implementations for the communication network 240 are for illustration purposes only. How a communication link 245 (not separately numbered) between the first server 210, the data source 230, the second server 220 and/or another electronic device (not shown) and the communications network 240 is implemented will depend inter alia on how each electronic device is implemented.

In one or more embodiments, the TLM 250 is a transformer deep neural network having a sequence-to-sequence (seq2sq) architecture including one or more encoder and/or decoder blocks. The TLM 250 uses an attention-mechanism that looks at an input sequence and decides at each step which other parts of the sequence are important. For each input, the attention-mechanism takes into account several other inputs at the same time and decides which ones are important by attributing different weights to those inputs. Implementations of TLMs are described for example in the article “On Extractive and Abstractive Neural Document Summarization with Transformer Language Models” by Subramanian et al. available on the arXiv preprint service (arXiv:1909.0318).

As a non-limiting example, the TLM 250 may comprise a single GPT-like transformer based on the OpenAl GPT model.

Once trained, the TLM 250 is configured to generate a discussion with a user, i.e. generating a response to a user input in a natural language format. As a non-limiting example, the TLM 250 may generate responses when the user input is a question. As another non-limiting example, the TLM 250 may generate responses when the user input is a comment, remark or any type of sentence during a discussion such as “I like movie X”.

Furthermore, the TLM 250 is configured to determine whether a recommendation for a particular item should be generated based on the user input. If it determines that no recommendation should be generated, the TLM 250 is used for continuing the discussion with the user as known in the art, i.e. the TLM 250 generates a discussion line which may be a question and outputs the discussion line. If it determines that a recommendation for a particular item should be generated based on the user input, the TLM 250 sends a query for an item recommendation to the recommendation engine of the second server 220. In one or more embodiments, the TLM 250 is configured to extract relevant information from the discussion with the user and insert the relevant information into the query. As a non-limiting example, the TLM 250 or the first server 210 may extract information by matching character sequences. The relevant information extracted from the discussion is chosen so as to help a recommendation engine for generating an accurate recommendation, such as the recommendation engine executed by the second server 220. The second server 220 may process the relevant information and determine an item to be recommended. The second server 220 then transmits the item to be recommended to the first server 210. The TLM 250 then accesses the knowledge source of the data source 230 to retrieve information about the item to be recommended. The TLM 250 is further configured for generating a response including the item to be recommended and the retrieved information and transmit, via the first server 210, the generated response to the electronic device from which the user input was received.

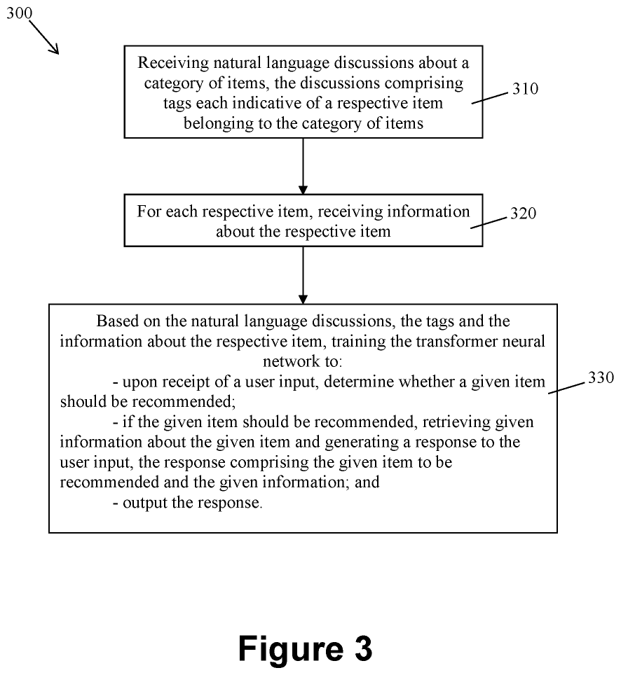

FIG. 3 illustrates one embodiment of a computer-implemented method 300 for training a TLM such as the TLM 250.

In one or more embodiments, the TLM 250 may be part of a recommendation engine such as the recommendation engine of the second server 220, or may be used by a recommendation engine via the API 225. The recommendation engine comprises the TLM 250 configured to generate natural language discussions with a user, i.e. to generate responses to user inputs such as user questions about items. The responses are generated in the form of natural language discussion lines, e.g. sentences, which integrate recommended item which may be provided by other components of the recommendation engine, as well as information retrieved from external data sources such as the data source 230.

Items may comprise movies, music, news, books, magazines, goods and services, web pages, etc. For example, the natural language model may be configured to recommend movies while generating a discussion with a user interested in movies.

In one or more other embodiments, the TLM 250 may be used by a recommendation engine via the API 225.

The computer-implemented method 300 is executed by an electronic device such as the electronic device 100, the first server 210 and/or the second server 220, the electronic device comprising a processor such as the processor 110 and/or the GPU 111 operatively connected to a non-transitory storage medium such as the solid-state drive 120 or the random-access memory 130 storing computer-readable instructions. The processor, upon executing the computer-readable instructions, is configured to or operable to execute the computer-implemented method 300.

At step 310, natural language discussions about a category of items are received. The discussions contain discussion lines written in natural language. It will be appreciated that the discussions may include one or more lines or sentences and each line may include one or more words. Each discussion line in which an item belonging to the category of items is mentioned and/or recommended is tagged.

At step 320, information about the item is received for each item tagged in the natural language discussion. In one embodiment, the information is in text format.

In one embodiment, the step 320 comprises accessing the data source 230 comprising a knowledge source and extracting relevant information about the item from the knowledge source. The knowledge source may comprise information in structured or unstructured format. As a non-limiting example, the knowledge source may comprise a collection of natural language documents such as a local collection of reference text, internal organization documents and web pages, compiled news reports, Wikipedia™ pages, and/or a plurality of web pages.

At step 330, the TLM 250 is trained based on the received natural language discussions, the tags indicating mentions of items in the natural language discussions and the received information about the tagged items. It will be appreciated that the TLM 250 may be pretrained prior to step 330 and may be further trained and fine-tuned during step 330.

The training of the TLM 250 enables the TLM to become configured to determine, upon receipt of a user input, whether a given item should be recommended based on the user input, if the given item should be recommended, retrieve given information about the given item, and generate and output a response to the user input. The response to the user input comprises the given item to be recommended and the given information, in a text format. The TLM 250 is conditioned to generate responses in the form of sentences by the tags and the received information about the tagged items.

In one embodiment, during the training, the TLM 250 learns to calculate the value for a recommend token and a not-recommend token for each user input. The recommend token is indicative that a recommendation for an item should be made while the not-recommend token is indicative that a recommendation for an item should not be made. If the determined value of the recommend token is greater than that of the not-recommend token, then the natural language model determines that a recommendation for an item should be generated. If the determined value of the recommend token is less than that of the not-recommend token, then natural language model determines that a recommendation for an item should not be generated. It will be appreciated that other types of thresholds may be used for determining if recommendations for an item should be generated based on the value of the recommendation token.

In one or more embodiments, the TLM 250 is trained to predict when a recommendation for an item must be made and a query is transmitted to a recommendation engine when a recommendation for an item must be generated. In this case, the system includes relevant information within the query to help the recommendation engine to generate a recommended item and for the TLM 250 to generate an accurate response.

In another embodiment, the TLM 250 is trained to generate recommendation of items itself to further act as a recommendation engine.

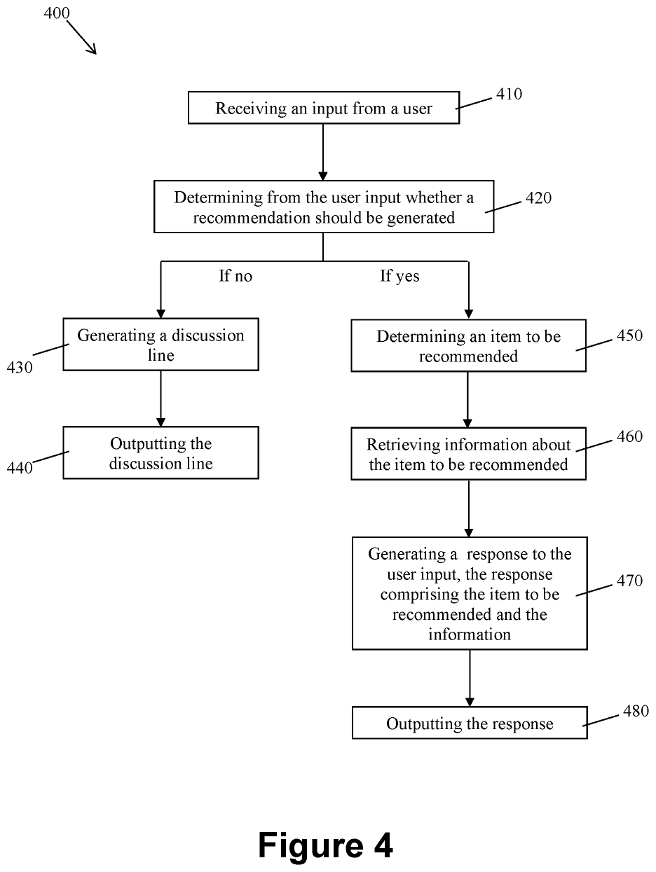

FIG. 4 illustrates one embodiment of a computer-implemented method 400 for recommending an item during a natural language discussion with a user by using the transformer language model (TLM) 250.

The computer-implemented method 400 is executed by an electronic device such as the electronic device 100, the first server 210 and/or the second server 220, the electronic device comprising a processor such as the processor 110 and/or the GPU 111 operatively connected to a non-transitory storage medium such as the solid-state drive 120 or the random-access memory 130 which stores computer-readable instructions. The processor, upon executing the computer-readable instructions, is configured to or operable to execute the computer-implemented method 400.

The TLM 250 has been previously trained as described above.

At step 410, a user input is received from a user electronic device. The user input is a line of a natural language discussion. In one embodiment, the user input is in text format. As a non-limiting example, the user input may be a question about a particular item or about a category of items. As another non-limiting example, the user input may be another type of sentence which includes a mention of the particular item and/or a category of items.

At step 420, it is determined based on the user input whether a recommendation for an item should be generated or not.

In one embodiment, the step 420 comprises determining the value for a recommend token and the value for the not-recommend token based on the user input. If the value of the recommend token is greater than that of the not-recommend token, then it is determined that an item should be recommended. Otherwise, it is determined that no item should be recommended. In one or more embodiments, the step 420 comprises performing string matching to match character sequences from the user input to instances of items belong to a category of items. The instances may have been learned by the natural language model, and/or may be compared to instances in a list from a database for example. The matching may be used to generate the value of the recommended or not-recommended token.

If it is determined that no item should be recommended, a discussion line which comprises no recommendation for an item is generated by the natural language model at step 430. For example, the discussion line may comprise a question related to the item category. The discussion line is then outputted at step 440. The discussion line may be transmitted to the user electronic device to be displayed thereon for example.

If it is determined that an item should be recommended, the item to be recommended is determined at step 450. In one embodiment, the natural language model is configured to determine the item to be recommended. In another embodiment, the system creates a query for a recommendation and the query is transmitted to a recommendation engine such as the recommendation engine executed by the second server 220 which returns the item to be recommended. The query may include information extracted from the user input to improve the relevance of the recommendation.

Once the item to be recommended has been determined, information about the item to be recommended is retrieved at step 460. For example, the information about the item to be recommended may be obtained from a knowledge source stored in the data source 230. In one embodiment, the system is configured for extracting only a part of the information about the item contained in the knowledge source. The information about the item may be as a non-limiting example an abstract of the item in the knowledge source.

At step 470, a response to the user input is generated. The response corresponds to a discussion line and contains the item to be recommended and the retrieved information about the item to be recommended. The response is in the form of a natural language discussion line in a dialogue.

At step 480, the generated response is outputted. The generated response may be transmitted to the user electronic device from which the user input has been received.

It will be appreciated that the generated response may be further output so as to generate a text-to-speech response. In one or more embodiments, the response may be displayed to the user of the electronic device.

While the above described system and methods are related to conversational recommendations, it should be understood that the systems and methods may be applied to a wide variety of goal-oriented dialogues.

In the following, there is described a particular application of the above-described systems and methods to recommendations of movies. The task is to provide recommendations on a particular set of movies through a dialog, without any prior knowledge of the user's preferences. The source of discussions to be used for the training of the natural language model may be Redial which is a dataset comprising dialogues of movie recommendation: one person, the seeker, asks for movie recommendations, and the other, the recommender, provides the recommendation. To obtain control and enhance the factual correctness of a transformer natural language model trained on this dataset textual information is inserted prior to each recommender's utterance. If the recommender's utterance recommends a given movie, e.g. “MovieXYZ”, the following control sequence is added before it: <recommend> MovieXYZ <facts> facts about MovieXYZ, where the text following the <facts> token comprises an abstract of that movie from DBpedia for example. A <not-recommend> token is pre-pended just before the actual recommender's utterance. If the recommender does not mention a movie in its utterance, the <not-recommend> token is just pre-pended.

During inference, the TLM may use some external information provided thereto via the <facts> sequence, and the TLM can be forced to recommend some movies given by an external recommendation engine, using the <recommend> sequence. The external recommendation engine and facts are described in more details below. Assuming that the external recommender and knowledge base are kept up-to-date, the TLM may be conditioned with information about movies just released in theaters for example. The recommendation system can thus recommend and discuss about movies that it has not even seen during training.

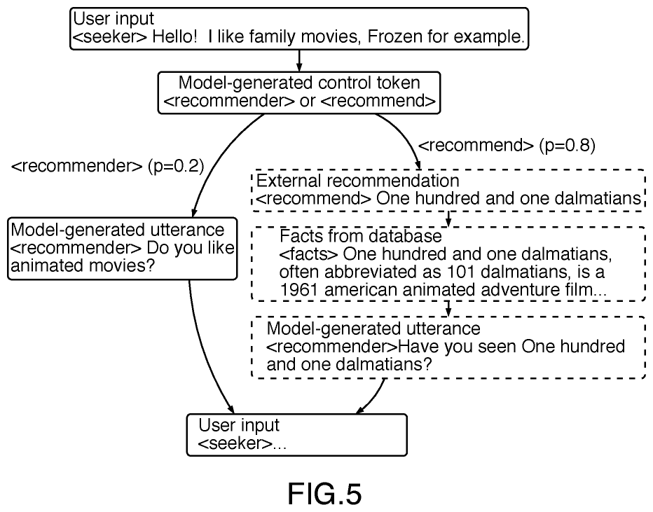

To generate the responses, the following process shown in FIG. 5 may be used.

First the transformer natural language model generates either a <recommend>or a <not-recommend> token. If it chooses to generate a <not-recommend> token, the transformer natural language model does not intend to recommend any movie in the utterance and continues the discussion generation as a typical language model would do. Alternatively, if a <recommend> token is generated, the following steps are executed:
Step 1: Append the recommended movie name from the external recommender system;
Step 2: Insert a <fact> token, followed by factual information about the movie selected for recommendation encoded as text; and

Step 3: Append a <not-recommend> token to signal that the transformer natural language model has to generate the actual text that will be transmitted to the user.

By training a transformer natural language model using data in this format the model implicitly learns to extract useful information from the facts previously inserted, and uses this information to augment its recommendations when generating the final utterance (in step 3 above). This also allows the transformer natural language model to answer to factual questions from the user provided that the answer is in the abstract given in the facts sequence.

It should be noted that any other adequate method for performing the generation may be used. For example, instead of using an external recommendation engine, the TLM could be trained to recommend movies, and then obtain facts based on the generated recommended movie. In one embodiment, making the transformer natural language model generate its intent before producing the utterance gives more control over it, and allows providing relevant external information that may enrich the response to the user input.

In an embodiment in which an external recommendation engine is used, it should be understood that any adequate engine configured for recommending movies from a dialogue or discussion may be used. In one embodiment, the recommendation engine may comprise a sentiment analysis module configured to, for every movie mentioned in the dialogue, determine if the user liked it or not. These sentiments are used as input to a classical recommendation engine, taking some observed movie ratings as input, and returning ratings for all the other movies, thus predicting the particular movies that the user is likely to appreciate. In one embodiment, the recommendation engine may leverage additional data such as the Movielens dataset, and thus provide high-quality recommendations, while being easy to keep up-to-date with the latest releases.

The factual information about the movie to be recommended is meant to provide useful insights about the movie. As described above, the factual information is obtained from a knowledge source. For example, DBpedia may be used as knowledge source to obtain the abstracts of movies, and use the abstract as factual information. These abstracts often contain information such as starring actors, director, a short plot summary, and/or the like. They usually contain a few sentences, and can easily fit in the window of a TLM.

In the following some experimental results are described.

Fine-Tuning on other Datasets

In order to improve the accuracy of the transformer natural language model when answering factual questions, the model is fine tuned on the Wizard of Wikipedia dataset (which is a conversational dataset of question answering based on Wikipedia articles), and on a synthetic dataset consisting of Wikipedia™ facts, followed by an utterance stating a fact about the movie: <facts> Some facts about movie XYZ <recommend> movie XYZ was directed by . . . for example. In the present experiments, it was chosen to include synthetic examples asking about actors and directors.

Setup

As known in the art, neural language generation models tend to imagine facts, all the more when it is about a very specific entity, such as information about an item in a conversational recommendation setting. The present experiment was performed to evaluate the accuracy of the present transformer natural language model when it elicits facts. We manually gathered from the Redial dataset a list of natural templates T1, . . . Tn where the recommender states a fact, referring to some relation (actor, director, music composer, or writer): <recommend> {movie} <facts> {facts} <recommender> have you seen {movie} ? it stars . . . for example, asking for actors. A random template and a random movie was chosen from the database and the {movie} and {facts} placeholders were replaced with the actual movie name and facts. The knowledge source provides the ground-truth answers to the synthetically created question. By doing this for 1500 movies seen during training and 1500 movies unseen during training, an evaluation dataset of 3000 examples is obtained. The transformer natural language model is conditioned with each of these examples and is let to generate the end of the sentence. The accuracy with which the model generates a correct name is measured. It should be noted that only one template is used in the training synthetic dataset, whereas the evaluation dataset contains several natural templates from the Redial dataset.

A TLM is pre-trained on Wikipedia™ and then fine-tuned on different datasets. The first variant “Wiki +redial” is fine-tuned on Wikipedia™ and the vanilla Redial dataset (without the added facts). This model has not learnt to condition on the facts so it just tries to answer the facts “by heart”. This model answering correctly means that the information was encoded in the model's weights just by training on Wikipedia™ and Redial. The “base=Wiki+redial with facts” model is fine-tuned on Wikipedia™ and the modified Redial dataset and thus learned to condition on the facts to generate its answer. The “base+synthetic” variant is fine-tuned on Wikipedia, the modified Redial, and the synthetic dataset described above. It is further trained to be able to answer questions about actors and directors. Finally, the “base +synthetic +wizard” variant is fine-tuned on WikipediaTM, modified Redial, the synthetic dataset, and the Wizard of Wikipedia™ dataset.

Results

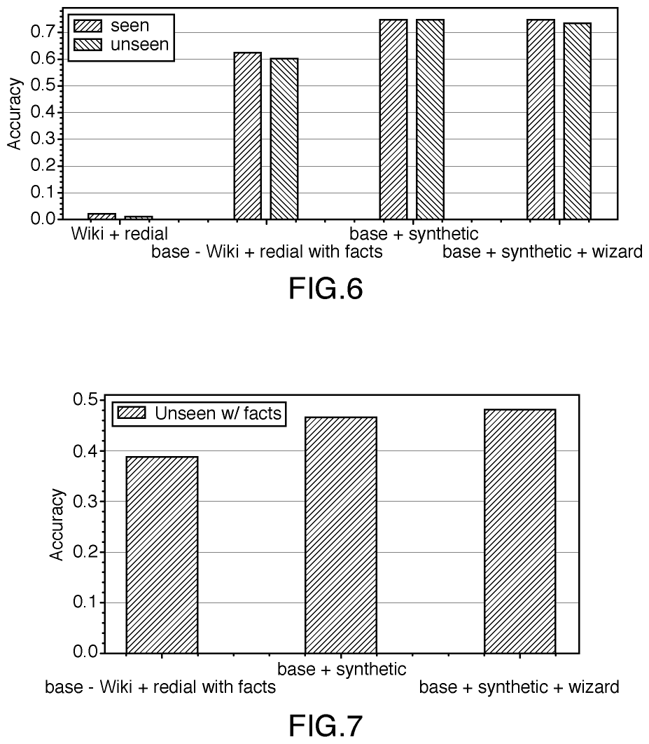

Results comparing our different fine-tuning variants are presented in FIGS. 6 and 7. FIG. 6 shows the results when evaluating the model only on actor and director questions, which are also the questions present in the synthetic dataset introduced above. The “Wiki+redial” variant performs poorly and only manages to give a few correct responses for movies it has seen during training, while being completely wrong for new movies. This is an expected behavior. Training the model to condition the facts brings a great improvement, as the “base” model reaches about 60% accuracy on both seen and unseen movies.

Adding the synthetic data into the training further improves the accuracy, up to roughly 75%. Adding the Wizard of Wikipedia dataset does not seem to improve the accuracy in the present case. It should be noted that for the last three variants, the accuracy is the same whether the movie was seen or not during training, thereby suggesting that the models did not memorize those answers from the training set, but effectively learned to condition on the facts to produce answers.

FIG. 7 shows the results on questions about the writer, which are not in the synthetic dataset. The performance of the base model on this task is lower than on the actor/director task: it reaches 40% accuracy. The main reason for this poorer performance is that the oracle performance, which is the percentage of abstracts that contain at least one of the ground-truth answers, is of 66% for writers, versus 91% for the actor and directors. In other words, the information about actors and directors is almost always present in the movie abstracts whereas the information about writers is more rarely present, which necessarily impairs the performance. Besides, questions or statements about the writer happen less often than those about the director or the actors in the Redial dataset. Interestingly, adding the synthetic data only composed of questions about the actor and the director also helps in this task, indicating that the synthetic dataset trains the model to condition on the whole facts and not just the actor and director information. Finally, the “base+synthetic+wizard” variant performs the best in this task with a 48% accuracy. Adding the more general QA dataset Wizard of Wikipedia helps the model to generalize to broader factual questions.

The present technology proposes to use special tokens to control and observe the intents of a transformer neural language model in goal-oriented dialogue tasks. While the above example is described in the context of movie recommendation dialogues, it should be understood that the present technology may be applied to other tasks. These intents dictate the behavior of the transformer natural language model, and can act as triggers for external components such as recommendation engines or knowledge sources. The external components provide additional relevant information to the transformer natural language model that makes the system more factually correct, and even allows the system to chat about new items which were unseen during training.

In comparison to prior art models that use control codes that target a broad domain (ex: “Funny”, “Gaming”, “India”), the present transformer natural language model provides a specific control on the behavior, and may be compared to an intent in a classical dialogue system. Considering a setting where a chatbot is giving a recommendation for a movie (or any other item) to a user, the present transformer natural language model allows inducing the intent recommend movie XXX to the model, forcing it to produce a sentence where the specified movie is recommended. The proposed method also adds facts about the movie that should be recommended, allowing the model to use these facts for enriching its answers, question-answering, and increasing the factual correctness of the model, even on items that were not seen during training. Practically, the control tokens act as triggers for external components: when the model produces the recommend intent at inference, an external recommender and a knowledge base are used to provide a recommendation and some facts, on which the model conditions to generate the following utterance. One could easily imagine other use-cases where the model could trigger actions by using certain tokens. For example, the TLM could learn to generate a DB query and run it with a trigger token. In a flight booking chat, the TLM could trigger the booking of a particular flight. More generally, one or more embodiments of the present technology bring the following improvements to a transformer neural language model in a dialogue setting:

Special tokens allow to control and/or observe the model's intent; and The tokens can act as triggers for external components such as recommender systems or knowledge bases, able to provide additional information to the model.

It will be appreciated that not all technical effects mentioned herein need to be enjoyed in each and every embodiment of the present technology. For example, one or more embodiments of the present technology may be implemented without the user enjoying some of these technical effects, while other non-limiting embodiments may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fiber-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting.

1. A computer-implemented method for training a transformer language model (TLM) to provide responses comprising item recommendation, the method being executed by a processor, the processor executing the TLM, the method comprising:
receiving natural language discussions about a category of items, the discussions comprising tags each indicative of a respective item belonging to the category of items;
for each respective item, receiving information about the respective item; and
based on the natural language discussions, the tags and the information about the respective item, training the TLM to:
upon receipt of a user input, determine whether a given item should be recommended based on the user input;
if the given item should be recommended, retrieving given information about the given item and generating a response to the user input, the response to the user input comprising the given item to be recommended and an indication of the given information; and
output the response to the user input.

2. The computer-implemented method of claim 1, wherein said response is generated in the form of a natural language dialogue sentence.

3. The computer-implemented method of claim 1, wherein
the processor is connected to a knowledge data source; and wherein
said retrieving given information about the given item comprises providing an indication of the respective item to the knowledge data source to receive the information therefrom.

4. The computer-implemented method of claim 1, wherein
to determine whether a given item should be recommended based on the user input, the TLM is trained to generate a control token comprising a recommendation value and a non-recommendation value; and wherein
said retrieving given information about the given item if the given item should be recommended is based on the recommendation value being above the non-recommendation value.

5. The computer-implemented method of claim 4, wherein said generating the control token comprises matching character sequences from the user input to items in the category of items.

6. The computer-implemented method of claim 1, further comprising:
generating, using a recommendation engine connected to the processor, based on the user input, the given item to be recommended.

7. The computer-implemented method of claim 1, further comprising if the given item should not be recommended, generating a discussion line about the category of items as the response.

8. A computer-implemented method for recommending items using a transformer language model (TLM) having been trained therefor, the method being executed by a processor, the method comprising:
receiving a user input comprising a natural language discussion line;
determining, based on the natural language discussion line, a given item related to a category of items;
generating, using the TLM, based on the item related to a category of items, a recommendation value;
if the recommendation value is above a threshold:
receiving a given recommended item from a recommendation engine;
receiving information about the given recommended item from a knowledge source;
generating, using the TLM, based on the information about the given recommended item and the given recommended item, a natural language response to the user input comprising the given recommended item and an indication of the information; and
outputting the natural language response.

9. The computer-implemented method of claim 8, further comprising, prior to said receiving the user input:
receiving natural language discussions about the category of items, the discussions comprising tags each indicative of a respective item belonging to the category of items;
for each respective item, receiving information about the respective item; and
based on the natural language discussions, the tags and the information about the respective item, training the TLM to generate natural language responses.

10. The computer-implemented method of claim 8, wherein the given recommended item has not been used to train the TLM.

11. A system for training a transformer language model (TLM) as part of a recommendation engine, the system comprising:
a processor; and
a non-transitory computer readable storage medium comprising instructions stored thereon;
the processor, upon execution of the instructions, being configured for:
receiving natural language discussions about a category of items, the discussions comprising tags each indicative of a respective item belonging to the category of items;
for each respective item, receiving information about the respective item; and
based on the natural language discussions, the tags and the information about the respective item, training the TLM to:
upon receipt of a user input, determine whether a given item should be recommended based on the user input;
if the given item should be recommended, retrieving given information about the given item and generating a response to the user input, the response to the user input comprising the given item to be recommended and an indication of the given information; and
output the response to the user input.

12. The system of claim 11, wherein said response is generated in the form of a natural language dialogue sentence.

13. The system of claim 11, wherein
the processor is connected to a knowledge data source; and wherein
said retrieving given information about the given item comprises providing an indication of the respective item to the knowledge data source to receive the information therefrom.

14. The system of claim 11, wherein
to determine whether a given item should be recommended based on the user input, the processor is configured for training the TLM to generate a control token comprising a recommendation value and a non-recommendation value; and wherein
said retrieving given information about the given item if the given item should be recommended is based on the recommendation value being above the non-recommendation value.

15. The system of claim 14, wherein said generating the control token comprises matching character sequences from the user input to items in the category of items.

16. The system of claim 11, wherein the processor is further configured for:
generating, using the recommendation engine connected to the processor, based on the user input, the given item to be recommended.

17. The system of claim 11, further comprising if the given item should not be recommended, generating a discussion line about the category of items as the response.

18. A system for recommending items using a transformer language model (TLM) having been trained therefor, the system comprising:
a processor; and
a non-transitory computer readable storage medium comprising instructions stored thereon;
the processor, upon execution of the instructions, being configured for:
receiving a user input comprising a natural language discussion line;
determining, based on the natural language discussion line, a given item related to a category of items;
generating, using the TLM, based on the item related to a category of items, a recommendation value;
if the recommendation value is above a threshold:
receiving a recommended item from a recommendation engine;
receiving information about the recommended item from a knowledge source;
generating, using the TLM, based on the information about the recommended item and the recommended item, a natural language response to the user input comprising the given item to be recommended and an indication of the given information; and
outputting the natural language response.

19. The system of claim 19, wherein the processor is further configured for, prior to said receiving the user input:
receiving natural language discussions about the category of items, the discussions comprising tags each indicative of a respective item belonging to the category of items;
for each respective item, receiving information about the respective item; and
based on the natural language discussions, the tags and the information about the respective item, training the TLM to generate natural language responses.

20. The system of claim 19, wherein the given recommended item has not been used to train the TLM.
